(19) United States
(12) Patent Application Publication
(10) Pub. No.: US 2006/0176697 A1
(43) Pub. Date: Aug. 10, 2006

(54) Combination light fixture and motion sensor apparatus

(76) Inventor: Steven S. Arruda, Westport, MA (US)

Correspondence Address: Steven S.Arruda, 9 Weetamoe Drive, Assonet, MA, 02702, US

(21) Appl. No.: 11/053,554

(22) Filed: Feb. 8, 2005

(51) Int. Cl. F21V 23/04

(52) U.S. Cl. 362/276; 362/100

(57) ABSTRACT

A combination light fixture and motion sensor apparatus contained in a single enclosure, which turns on automatically when approached and which turns off automatically when the area is vacated, is disclosed. In particular, this apparatus is one that can be mounted in a closet, pantry, cabinet, under a cabinet, or an area where wiring a separate light and switch is not feasible or practicable. The combination light fixture and motion sensor apparatus is contained within a single enclosure, and the apparatus may be mounted inside a closet and above the closet door. By being mounted above the door, the motion from the door being opened triggers the motion sensor so that the light will come on automatically. The apparatus also turns off the light automatically when not needed, so as to save energy.

### BACKGROUND OF THE INVENTION

1. Technical Field

This invention relates generally to light fixtures and lighting controls. More specifically, the present invention is directed to a combination light fixture and motion sensor apparatus.

2. Description of the Related Art

A conventional closet, particularly as found in older homes, may not have a light fixture of any type in it, which can make it difficult for someone entering the closet to find what they are looking for. Some closets do have a simple light bulb in them that is activated by a pull string or chain. The user must turn off the light when the user leaves the closet by re-pulling on the string. Inventors have over the years tried to find other ways to install or provide a light source in a closet. Generally, installing a light source in a closet involves electrically “hard-wiring” the light into the closet ceiling and a switch into the adjacent wall. Some people who wish to avoid the trouble and expense of installing new electrical wiring in both a ceiling and wall, use simple battery-operated lights that are easy to install on a closet ceiling or wall.

Much effort has gone into achieving the goal of installing a light source in a closet with as little work as possible. There are a variety of automatic “closet lights” available. One example is an electric door light switch in which automatic lights are positioned to sit inside the door jamb and the lights are activated using a momentary push-button switch that is mounted inside the door jamb and that is configured to open (i.e., turn off power to the lights) when the door is closed. When the door is opened, the switch returns to its normally closed state and the lights come on in much the same way that the light comes on in a conventional refrigerator. This push-button switch solution, however, suffers from a number of drawbacks. For instance, the placement and dimensions of the push-button switch vis-à-vis the door must be correct in order to ensure the proper operation of the light. In addition, the reliance on a mechanical switch (which may fail after repeated use) tends to reduce the reliability of the system. Moreover, the use of a switch having of a non-standard type and size, at least in relation to those switches typically used for home wiring, has a negative impact on the cost of such a solution, as well as the ability of a user to locate a suitable replacement switch, should the switch fail.

What is needed, therefore, is simple and reliable form of lighting that may be readily installed without extensive effort. The present invention provides a solution to this and other problems, and offers other advantages over previous solutions.

### SUMMARY OF THE INVENTION

Accordingly, a preferred embodiment of the present invention provides a combination light fixture and motion sensor apparatus contained in a single enclosure, which turns on automatically when approached, for convenience, and which turns off automatically when the area is vacated, for energy-saving purposes. In particular, this apparatus is one that can be mounted in a bathroom closet, closet, pantry, cabinet, under a cabinet, or an area where wiring a separate light and switch is not feasible or practicable. The combination light fixture and motion sensor apparatus is contained within a single enclosure, and the apparatus may be mounted inside a closet and above the closet door. By being mounted above the door, the motion from the door being opened triggers the motion switch so that the light will come on automatically. The apparatus also turns off the light automatically when not needed, so as to save energy. A preferred embodiment of the present invention is mounted to a door jamb and comprises an enclosed structure with a pair of lights and a motion sensor positioned between the two lights.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1 is a perspective view of a combination light fixture and motion sensor apparatus in accordance with a preferred embodiment of the present invention;

FIG. 2 is a cross-sectional/perspective view of a combination light fixture and motion sensor apparatus, according to a preferred embodiment of the present invention, showing the relative position of the apparatus when mounted in the top of a door jamb in relation to a door that is ajar;

FIGS. 3A-3C are diagrams providing various orthographic projection views of an alternative embodiment of the present invention intended for use in conjunction with a sliding door assembly; and

FIG. 4 is a schematic diagram illustrating the connections between the various electrical components of a preferred embodiment of the present invention.

### DETAILED DESCRIPTION OF PREFERRED EMBODIMENT(S)

The following is intended to provide a detailed description of an example of the invention and should not be taken to be limiting of the invention itself. Rather, any number of variations may fall within the scope of the invention, which is defined in the claims following the description.

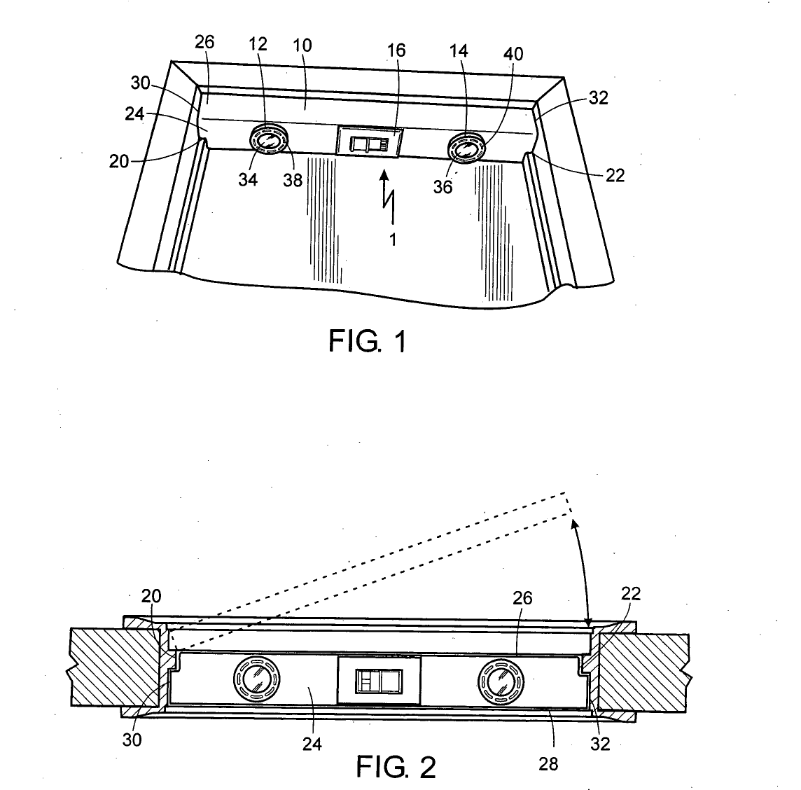

Referring now to the drawings, and more particularly to FIGS. 1 and 2, wherein like numbers refer to similar parts, a combination light fixture and motion sensor apparatus 1 is provided in a single enclosure 10 and is shown according to the present invention. Apparatus 1 includes at least one light 12 and at least one motion sensor 16. In the preferred embodiment depicted in FIGS. 1 and 2, apparatus 1 will comprise a pair of lights 12 and 14 and a motion sensor 16 located positioned between lights 12 and 14. In a preferred embodiment having multiple lights, at least one light is mounted on each side of motion sensor 16, as shown in FIG. 1. In an actual embodiment, multiple motion sensors may be employed, as well.

Enclosure 10 is an enclosed single unit with a top side 24, a bottom side (not shown), a front side 26, and a back side 28. Enclosure 10 may be constructed from any of a number of possible materials, including (but not limited to) a composite alloy, fiberglass, aluminum, wood, galvanized steel, thin steel, steel, plastic, injection-molded plastic, and other similar materials. Enclosure 10 has right-angled slots 20 and 22 on opposite ends of front side 26 and back side 28 (left side 30 and right side 32, respectively, of enclosure 10). Slots 20 and 22 are used to position enclosure 10 within a door jamb, as shown in FIGS. 1 and 2. Enclosure 10 is mounted to the doorjamb using wood screws (in a preferred embodiment, three wood screws are used). The bottom side, which is not depicted, is a flat surface containing an opening that is large enough to allow electrical wiring to extend outward from within apparatus 1 to an external power source. This electrical wiring may comprise a standard power cord terminated with a 2- or 3-prong plug, for connecting to an electrical outlet. Alternatively, the electrical wiring may comprise non-terminated wires, for direct “hard-wiring” to a power source, or may comprise wires that are terminated in connectors other than a standard 2- or 3-prong plug.

Lights 12 and 14 are preferably recessed can lights. In the preferred embodiment depicted in FIGS. 1 and 2, each of lights 12 and 14 comprises a surface can (not shown), a housing (housings 38 and 40), a reflector (not shown), lens cover (lens covers 36 and 38), and an incandescent or fluorescent light bulb (not shown). Each of housings 38 and 40 is secured to enclosure 10 with a retaining nut.

As shown in FIG. 2, the relative placement of apparatus 1 with respect to its corresponding door/door jamb places the door within the field of view of motion sensor 16. This allows lights 12 and 14 to be switched ON in response to movement of the door. Thus, in a typical closet door jamb installation, lights 12 and 14 will automatically be switched ON when the closet door is opened.

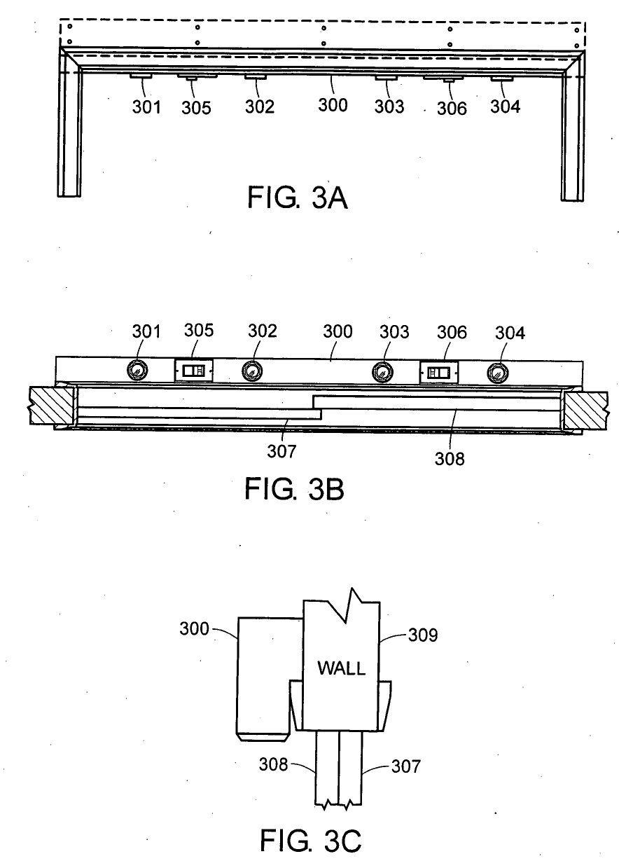

FIGS. 3A-3C depict an alternative embodiment of the present invention for use in conjunction with a sliding door or pair of sliding doors. As shown in FIG. 3A, apparatus 300 is a single assembly adapted to be installed above a set of sliding doors. FIG. 3B is an orthographic projection showing apparatus 300 as seen from below. As shown in FIG. 3B, apparatus 300, which is sized to accommodate the larger width of a sliding door assembly, includes four recessed can lights 301-304 interspersed with two motion sensors 305 and 306. Movement of either door 307 or 308 will trigger one or more of motion sensors 305 and 306, thus resulting in lights 301-304 being turned ON. Since a typical sliding door assembly will not accommodate a device being mounted within a door jamb, apparatus 300 is adapted to be mounted to the wall (e.g., wall 309) above the sliding door assembly. Apparatus 300, in typical usage, is mounted on the side of wall 309 that faces the space to be illuminated by lights 301-304. Thus, when apparatus 300 is used in conjunction with a closet, apparatus 300 will be mounted within the closet.

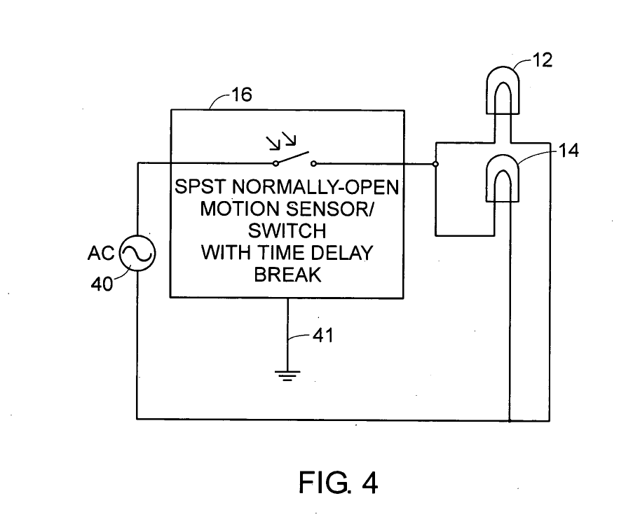

FIG. 4 is a schematic diagram illustrating the connections between the various electrical components of a preferred embodiment of the present invention. One terminal of power source 40, which will typically be AC (alternating current) mains power (typically 110 V, 60 Hz in the United States), is connected through motion sensor/switch 16 to lights 12 and 14, which are wired in parallel with respect to each other, with the other terminal of power source 40 being connected to parallel-wired lights 12 and 14 to form a complete circuit. One of ordinary skill in the art will recognize, however, that power sources other than AC mains power may be utilized, without limitation, in an actual embodiment of the present invention without departing from the scope and spirit of the present invention. Motion sensor/switch 16, in addition to its switch terminals, may also include a connection to ground 41.

Motion sensor/switch 16 is a single-pole, single throw (SPST) normally-open motion-activated switch, such as a DECORA Wall Switch Occupancy Sensor, Model ODS10-ID, manufactured by Leviton Mfg. Co., Inc. of Little Neck, N.Y. Motion sensor/switch 16 includes a passive infrared (PIR) motion sensor that detects motion of a source of thermal energy (such as body heat) within its field of view (area of coverage). When motion is detected, the normally-open SPST switch is closed, to complete the circuit and cause lights 12 and 14 to be activated (turned ON). When motion is no longer detected, motion sensor/switch 16 continues to be in a closed (ON) state for a selected period of time (the “delayed-OFF time”) before returning to its quiescent open (OFF) state. Thus, lights 12 and 14 remain on for the selected delayed-OFF time before automatically switching OFF. In a preferred embodiment utilizing aforementioned DECORA sensor/switch, a user may adjust the switch so as to choose a desired delayed-OFF time from a plurality of possible times (e.g., 30 seconds, 10 minutes, 20 minutes, etc.). Motion sensor/switch 16 is preferably also equipped with sensitivity controls, which enable the user to adjust the sensitivity of the motion sensor to ambient light; this allows the user to configure motion sensor/switch 16 so as to prevent lights 12 and 14 from turning ON during periods of ample natural light, thus conserving energy. In this preferred embodiment, a manual override control (a slide switch) is also available to allow lights 12 and 14 to be switched ON by actuating the manual switch. Motion sensor/switch 16 also supports a manual-OFF mode (as opposed to the normal “automatic” mode) wherein switch 16 may be open only by way of the manual override control to prevent lights from being unnecessarily activated. Motion sensor/switch 16 also includes an LED indicator; the LED indicator light is normally OFF when motion sensor/switch 16 is in automatic mode and flashes when motion is detected. Motion sensor/switch 16, in this preferred embodiment, is intended to be used with rapid-start fluorescent or incandescent lighting only.

The DECORA motion sensor/switch used in a preferred embodiment of the present invention is adapted to fit within a standard wall box (as used for electrical outlets and wall switches). This is advantageous in that it allows the apparatus to be repaired easily in the event of a failure of motion sensor/switch 16, since a suitable replacement/substitute sensor/switch may be readily obtained from off-the-shelf components manufactured for use in home/office wiring. One of ordinary skill in the art will recognize, however, that although a preferred embodiment of the present invention utilizes the aforementioned DECORA or similar sensors, any of a number of different motion sensors may be utilized in an actual embodiment of the present invention without limitation and without departing from the scope and spirit of the present invention.

While particular embodiments of the present invention have been shown and described, it will be obvious to those skilled in the art that, based upon the teachings herein, changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an;” the same holds true for the use in the claims of definite articles.

What is claimed is:

1. An apparatus for use in conjunction with a door, the apparatus comprising:
a structure adapted to be mounted above the door;
at least one light physically associated with the structure; and
a motion-activated switch physically associated with the structure and the at least one light, wherein the motion-activated switch is positioned relative to the structure such that when the structure is mounted above the door, the door lies within an area of coverage of the motion-activated switch and movement of the door causes the motion-activated switch to turn on the at least one light.

2. The apparatus of claim 1, wherein the structure forms an enclosure, the enclosure includes an opening on at least one side, the at least one light and motion-activated switch are mounted to the enclosure, and electrical wiring for providing power from an external source to the apparatus extends outward from of the enclosure's interior through the opening.

3. The apparatus of claim 2, wherein the electrical wiring is terminated in a plug that is adapted for connection to an electrical outlet.

4. The apparatus of claim 1, wherein the structure is adapted to be mounted within a doorjamb associated with the door.

5. The apparatus of claim 1, wherein the structure is adapted to be mounted to a wall above the door.

6. The apparatus of claim 1, wherein the door is a sliding door.

7. The apparatus of claim 1, wherein the motion-activated switch detects motion by way of an infrared sensor.

8. The apparatus of claim 1, wherein the motion-activated switch is sized to fit a standard electrical wall box.

9. The apparatus of claim 1, wherein in response to the motion-activated switch's failing to detect continued movement following a detection of movement, the motion-activated switch causes the at least one light to maintain an on-state for a pre-determined length of time prior to automatically switching the at least one light to an off-state.

10. A method comprising:
installing a motion-activated switch in proximity to a door such that motion of the door causes the motion-activated switch to close; and
installing an electrical lighting circuit in conjunction with the motion-activated switch and with a power source such that closure of the motion-activated switch causes the electrical lighting circuit and power source to form a closed circuit.

11. The method of claim 10, wherein the motion-activated switch and electrical lighting circuit are mounted to an enclosure and the motion-activated switch, electrical lighting circuit, and enclosure are installed as a unit.

12. The method of claim 11, wherein installing the unit includes:
mounting the enclosure to an interior of a door jamb.

13. The method of claim 11, wherein installing the unit includes:
mounting the enclosure to a wall that is in proximity to the door.

14. The method of claim 13, wherein the door is a sliding door.

15. The method of claim 10, further comprising:
plugging at least one of the electrical lighting circuit and the motion-activated switch into an electrical outlet.

16. The method of claim 10, further comprising:
wiring at least one of the electrical lighting circuit and the motion-activated switch to an external power source.

17. An apparatus comprising:
an enclosure having a first side, a first end, and a second end, the enclosure including slots at the first end and second end that are adapted to conform to a shape of a door jamb;
a motion-activated switch having a motion sensor and being mounted to the enclosure such that the motion sensor is exposed from the first side of the enclosure; and
at least one light mounted to the enclosure such that the at least one light is exposed from the first side of the enclosure, wherein the motion-activated switch, in response to detecting motion, causes the at least one light to turn on.

18. The apparatus of claim 17, wherein the motion-activated switch is sized to fit a standard electrical wall box.

19. The apparatus of claim 17, wherein the at least one light includes a recessed can light.

20. The apparatus of claim 17, further comprising:
electrical wiring extending outward from an interior of the enclosure through an opening in the enclosure, the electrical wiring being adapted to connect the motion-activated switch and the at least one light to an external power source.
